(19) United States
(12) Patent Application Publication
(10) Pub. No.: US 2025/0363048 A1
(43) Pub. Date: Nov. 27, 2025

(54) TECHNIQUES FOR MAPPING TABLE SIZE REDUCTION

(71) Applicant: MICRON TECHNOLOGY, INC., Boise, ID (US)

(72) Inventors: Donghua Zhou, Suzhou City (CN); Meng Wei, Shanghai (CN)

(21) Appl. No.: 19/178,410

(22) Filed: Apr. 14, 2025

Related U.S. Application Data
(60) Provisional application No. 63/651,229, filed on May 23, 2024.

(51) Int. Cl. G06F 12/02

(52) U.S. Cl. CPC G06F 12/0246; G06F 2212/1016; G06F 2212/7201

(57) ABSTRACT

A processing device in a memory sub-system receives a request to write data to a memory device, the request comprising a data item and a logical address. The processing device allocates a plurality of pages of the memory device to a page set, wherein the plurality of pages are associated with a same block of the memory device and sequentially numbered within the same block. The processing device writes the data to the page set and modifies, in an address translation data structure (ATDS), a logical address mapping of a translation unit (TU) associated with the page set.

### RELATED APPLICATIONS

This application claims the benefit of U.S. Provisional Patent Application No. 63/651,229 filed May 23, 2024, entitled “Techniques for Mapping Table Size Reduction” which is incorporated by reference herein.

### TECHNICAL FIELD

Embodiments of the disclosure relate generally to memory sub-systems, and more specifically, relate to techniques for mapping table size reduction.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a flow diagram of an example method 200 to allocate multiple physical pages to a single TU, in accordance with some embodiments of the present disclosure.

FIG. 3 is a block diagram illustrating a computing system with an address mapping table for a memory sub-system using translation unit sizes in accordance with some embodiments of the present disclosure.

FIG. 4 is a flow diagram illustrating an example method of writing the data to the page set such that releasing the buffer of the memory device for subsequent commands is prioritized, in accordance with some embodiments of the present disclosure.

FIG. 5 is a flow diagram illustrating an example method of writing the data to the page set such that performance is prioritized by dispersing sequential write operations across multiple parallel dies, in accordance with some embodiments of the present disclosure.

FIG. 6 is a flow diagram illustrating an example method of writing the data to the page set such that parity is prioritized, in accordance with some embodiments of the present disclosure.

FIG. 7 is a flow diagram illustrating an example embodiment of a coherence check, performed in accordance with some embodiments of the present disclosure.

FIG. 8 is a block diagram of an example computer system in which embodiments of the present disclosure may operate.

### DETAILED DESCRIPTION

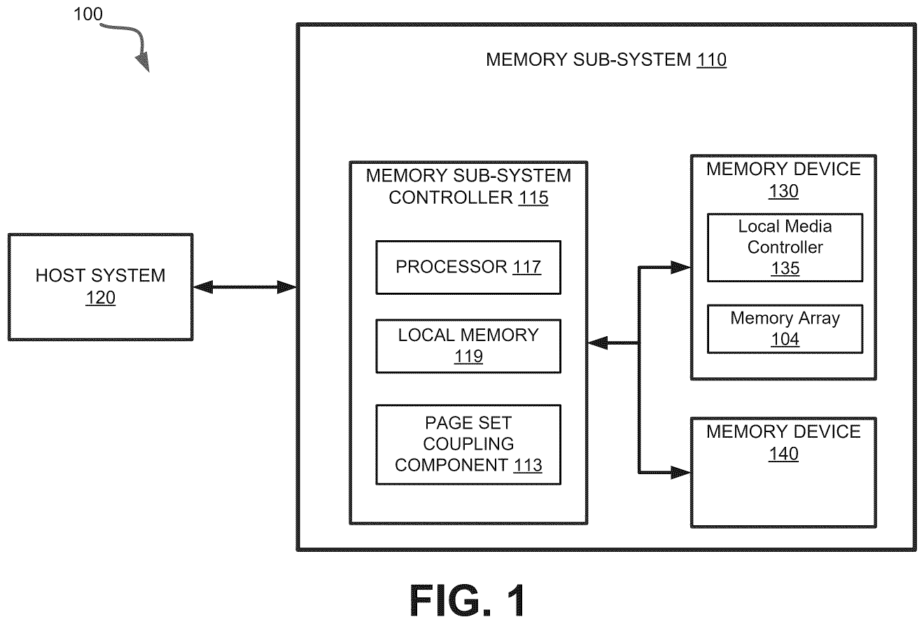

Aspects of the present disclosure are directed to techniques for mapping table size reduction. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device (e.g., a memory die) can include multiple memory cells arranged in a two-dimensional grid. Memory cells are formed (e.g., etched) onto a silicon wafer in an array of columns (interconnected by conductive lines that are hereinafter referred to as bitlines) and rows (interconnected by conductive lines that are hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

One example of a memory sub-system is a solid-state drive (SSD) that includes one or more non-volatile memory devices and a memory sub-system controller to manage the non-volatile memory devices. A memory sub-system can use a Flash Translation Layer (FTL) to translate logical addresses of memory access requests, referred to as logical block addresses (LBAs), to corresponding physical memory addresses, which can be stored in one or more address translation data structures (ATDS). In some embodiments, the ATDS can be implemented as a logical-to-physical (L2P) mapping table storing L2P mapping information, at least a portion of which may be stored in volatile memory (e.g., Dynamic Random Access Memory (DRAM)) in the memory sub-system so that it can be accessed with minimal latency. During operation, the memory sub-system can receive (e.g., from a host system) a write command specifying one or more data items to be stored. The write command can further specify, for each data item, a corresponding LBA and can have a fixed size (e.g., 4 kilobytes). Each data item is then written to the non-volatile memory devices at corresponding physical memory addresses, at the granularity referred to as a logical translation unit (TU). The TU is the base granularity of data managed by the memory sub-system and can include a predefined number of logical units (e.g., logical pages, logical blocks, etc.). When the TU is written to the physical memory address, the memory sub-system controller can create a corresponding entry in the L2P mapping table indicating the correlation between the LBA and the physical memory address. Thus, the L2P mapping table can include an entry for every TU written to the non-volatile memory device. As the size of the non-volatile memory device increases (e.g., into the tens of terabytes), the size of the volatile memory needed to store the L2P mapping information quickly surpasses practical limitations including cost, physical size, power utilization, etc.

The L2P mapping table size can be calculated as the product of the LBA size and the TU count. Thus, one approach that can reduce the size of the mapping table is to increase the TU size. For example, increasing the TU size from the standard size (e.g., 4 KB) to larger sizes (e.g., 16 KB or 32 KB), may significantly decrease the mapping table's size. By increasing the TU size to 16 KB, the total number of TUs required can be reduced to one-quarter of its original count. Similarly, if the TU size is further increased to 32 KB, the count can be decreased to one-eighth.

Increasing the TU size beyond the size of a page (e.g., greater than 16 KB) can further reduce the size of the L2P table. However, this necessitates the use of multiple physical pages for a single TU. For instance, if a TU is 32 KB while the physical page size is 16 KB, a single TU would need to span two physical pages. The need to span a single TU across two or more physical pages increases the complexity of the mapping table, as the firmware must accurately track and manage the locations of the multiple parts of the TU. To overcome this complexity, one approach is to logically couple the two or more pages to form a “page set.” For example, if the TU is 32 KB and each page is 16 KB, two physical pages are coupled together to store the entire TU. This allows for the efficient management and access of larger data blocks.

Coupling is typically performed across a multi-plane wordline (i.e., a wordline spanning multiple planes of the memory device). However, challenges may arise with page sets spanning planes. One such challenge is avoiding bad blocks, which are areas of the memory that can no longer reliably store data. The location of bad blocks cannot be forescen and thus, when attempting to form page sets, the presence of bad blocks can complicate the selection process. If a bad page (i.e., a page of a bad block) exists between two otherwise consecutive pages, it disrupts the ability to form a reliable page set, thus necessitating complex algorithms to identify suitable pairs of pages that are both healthy and consecutive.

Another challenge involves ensuring that coupled pages are not located across different dies. Coupling pages across dies can lead to inefficient use of the memory, increasing latency as the SSD controller has to manage data across different physical components. Reading from or writing to a page set that spans multiple dies would require coordinating operations across these dies, thus complicating the command execution process and potentially reducing performance due to increased overhead. Moreover, data stored across different dies may complicate error correction coding (ECC) and L2P mapping table updates, among other effects.

Aspects of the present disclosure address the above and other deficiencies by implementing a system for allocating multiple physical pages to a single translation unit (TU). In one embodiment, the memory controller of a memory device receives a command to write data to the memory device. This request includes a data item and a logical address associated with the data item. In response, the memory controller allocates pages from the memory device to form a page set. The number of pages allocated to a page set is dependent on the size of a physical page and the size of a translation unit. For example, where each physical page has a size of 16 KB (kilobytes) and a translation unit is 32 KB, two physical pages are allocated to each translation unit. In addition, in this embodiment, each page in a page set is associated with the same block of the memory device and organized sequentially within the same block. The write operation is performed to write the data to available pages in the memory device which have been allocated to page sets. Then, the address translation data structure (ATDS) (e.g., an L2P table) is updated accordingly. In updating the table, the logical address mapping of a translation unit associated with the page set is modified.

This method of coupling allows for the use of techniques that further improve performance. The method in which the write operation is performed may vary across embodiments depending on the priorities of the user and system. For example, in some embodiments, the write operation prioritizes releasing the write data buffer for subsequent commands. In some embodiments, the write operation prioritizes performance. In some embodiments, the write operation prioritizes parity. Further details regarding the write operations of exemplary embodiments are described below.

Advantages of the present disclosure include, but are not limited to, reducing latency, increasing SSD performance, and improving the overall reliability of the memory device. By allocating pages that are sequentially numbered within the same block of the memory device the present disclosure can avoid coupling bad pages into a page set. This enhances the overall reliability of the memory device. Furthermore, this method of coupling means that there is no risk of page sets including pages from multiple dies, reducing operational latency and improving the SSD's overall performance. Moreover, this approach allows for the optimization of error correction coding (ECC). With page sets localized to a single die, ECC can be tailored to specific die characteristics, enhancing error detection and correction efficiency.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a Page Set Coupling component 113 that can implement a system for allocating multiple physical pages to a single translation unit (TU). Upon receiving a request to write data to the memory device, the Page Set Coupling component 113 can logically couple pages of the memory device to a page set. The coupled pages are sequentially numbered within a common block. The Page Set Coupling component 113 writes the data to the page set and modifies, in an address translation data structure (ATDS) (e.g., a Logical-to-Physical Mapping Table), the logical address mapping of a TU associated with the page set. In some embodiments, the memory sub-system controller 115 includes at least a portion of the Page Set Coupling component 113. In some embodiments, the Page Set Coupling component 113 is part of the host system 120, an application, or an operating system. In other embodiments, local media controller 135 includes at least a portion of Page Set Coupling component 113 and is configured to perform the functionality described herein. Further details with regards to the operations of the Page Set Coupling component 113 are described below.

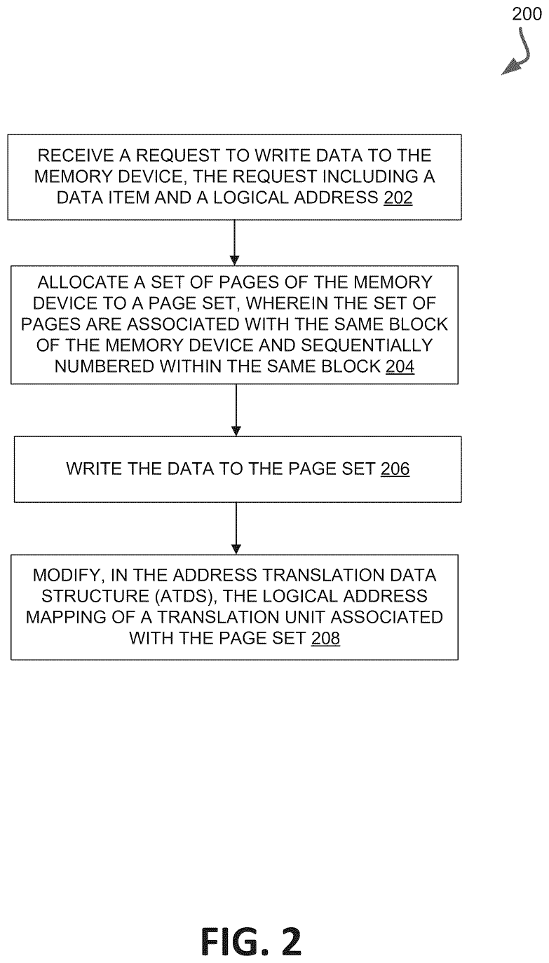

FIG. 2 is a flow diagram of an example method 200 to allocate multiple physical pages to a single TU, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the Page Set Coupling component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

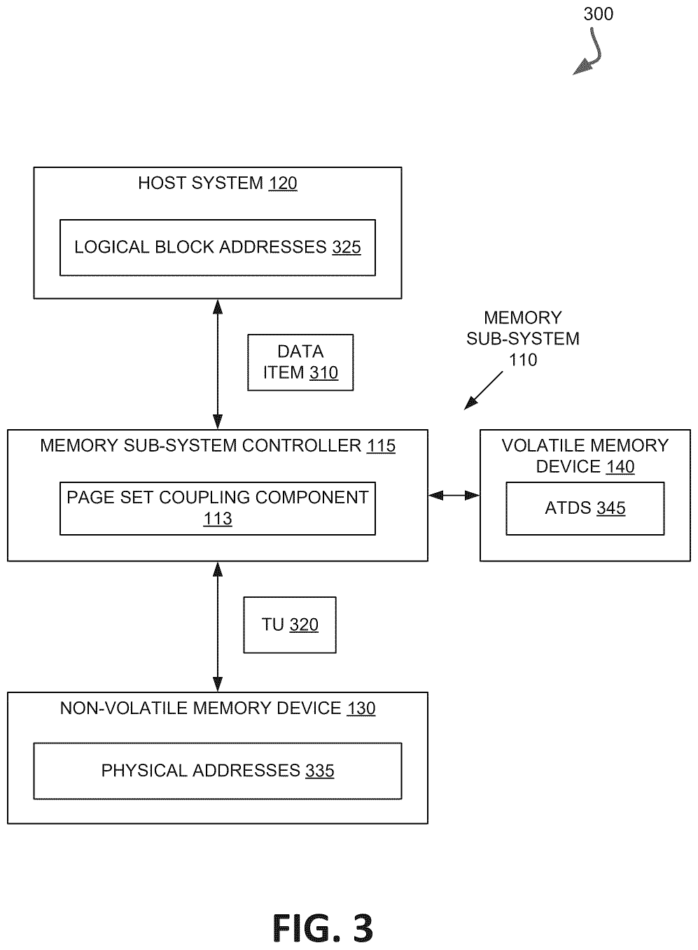

At operation 202, the processing logic (e.g., Page Set Coupling component 113) receives a request to write data to a non-volatile memory device, such as memory device 130. In one embodiment, as illustrated in FIG. 3, the requests (e.g., write commands) are received by memory sub-system controller 115 of memory sub-system 110, from a requestor, such as host system 120. In one embodiment, each request includes a data item 310, and an associated logical block address 325. Depending on the nature of the request, the request can include any number of data items 310 and associated logical block addresses 325.

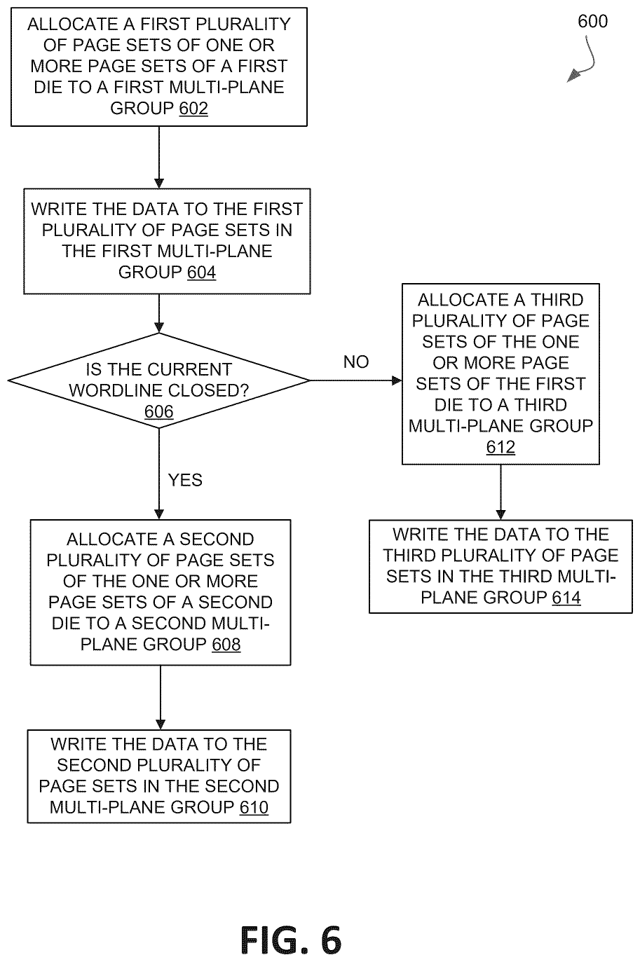

In some embodiments, the processing logic writes the data from the write command to a buffer memory of the memory device (hereafter referred to as a “buffer”). In some embodiments, this buffer is a temporary storage area within the SSD's memory for data to be written to the page set. In some embodiments, this buffer is located in volatile memory (e.g., Dynamic Random Access Memory (DRAM)) in the memory sub-system so that it can be accessed with minimal latency. It can allow the SSD controller to efficiently organize the data before writing it to the memory device. For example, NAND flash memory has specific requirements for how data must be written, such as writing data in page-sized chunks and only being able to erase data in larger block-sized units. In addition, it can be used to compensate for a speed difference between the interface through which the data is received and the slower process of writing the data to the memory device (e.g., to a page set). In some embodiments, the buffer is a temporary storage area within the SSD's memory for parity data, which is elaborated upon in FIG. 6.

At operation 204, the processing logic allocates a plurality of pages of the memory device to a page set, wherein the plurality of pages are associated with the same block of the memory device and sequentially numbered within the same block.

At operation 206, the processing logic writes the data to the page set. In some embodiments, the processing logic performs the write operation to write the requested data to non-volatile memory device 130 (e.g., a page set) using respective translation units, such as TU 320 of FIG. 3.

In different embodiments, the method in which the write operation is performed may vary depending on the priority of the user and/or system.

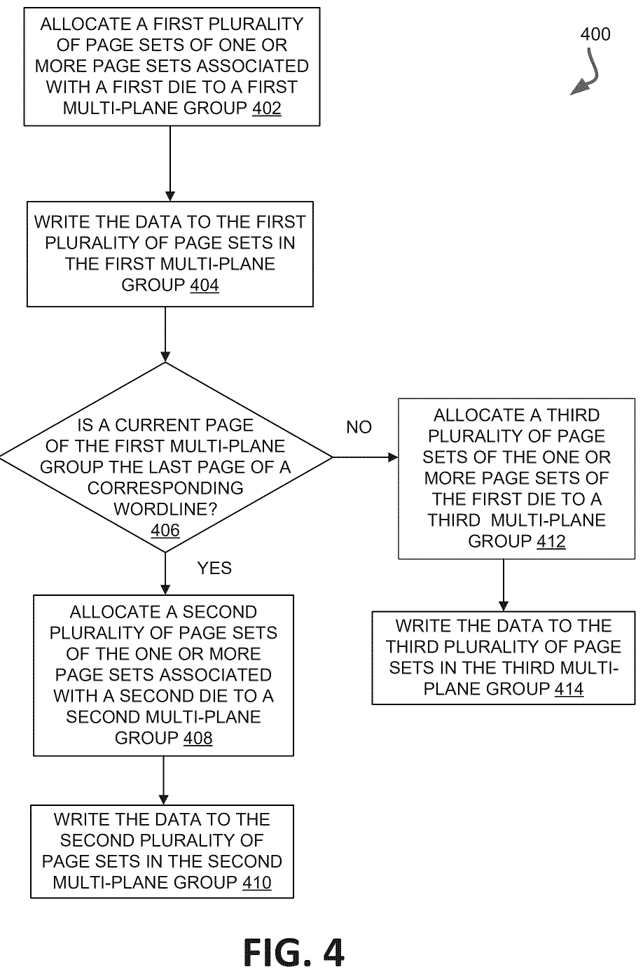

For example, in one embodiment, writing the data to the memory device can be performed such that it prioritizes releasing the buffer of the memory device for subsequent commands. FIG. 4 is a flow diagram of an example method of writing the data to the page set that prioritizes releasing the buffer, in accordance with some embodiments of the present disclosure.

At operation 402, the processing logic allocates a first plurality of page sets of one or more page sets associated with a first die to a first multi-plane group. The first plurality of page sets in the first multi-plane group includes a page set from each plane in the first die. The number of page sets in a multi-plane group can vary depending on the embodiment. In some embodiments, the number of allocated page sets in a multi-plane group is fixed and predetermined by the processing logic.

At operation 404, the processing logic writes the data to the first plurality of page sets in the first multi-plane group.

At operation 406, the processing logic determines whether a current page of the first multi-plane group is the last page of a corresponding wordline. A current page is a page that is currently being written to. The last page is the end page of the corresponding wordline. In some embodiments, the last page of a corresponding wordline is identified by its page type. For example, in a NAND memory device using a Triple-level cell (TLC) storage implementation, pages are categorized into three types: Lower Page (LP), Upper Page (UP), and Extra Page (XP). In an example wordline, the last page in a current wordline may be predetermined to be of the type XP.

Responsive to determining that a current page of the first multi-plane group is the last page of a corresponding wordline, at operation 408, the processing logic allocates a second plurality of page sets of one or more page sets associated with a second die to a second multi-plane group. The processing logic moves on to a subsequent die in the memory device. Like with the first plurality of page sets of operation 402, the second plurality of page sets in a multi-plane group includes a page set from each plane in the second die.

At operation 410, the processing logic writes the data to the second plurality of page sets in the second multi-plane group.

Responsive to determining that a current page of the first multi-plane group is not the last page of a corresponding wordline, at operation 412, the processing logic allocates a third plurality of page sets of the one or more page sets of the first die to a third multi-plane group. Unlike with operation 408, the processing logic determines that the last page in the current wordline has not been reached. As such, the processing logic allocates another plurality of page sets from the current die to a multi-plane group (in this case, the third multi-plane group) to be written to until the last page of the wordline is reached.

At operation 414, the processing logic writes the data to the third plurality of page sets in the third multi-plane group.

In another embodiment, writing the data to the memory device can be performed such that performance is prioritized by dispersing sequential write operations across multiple dies.

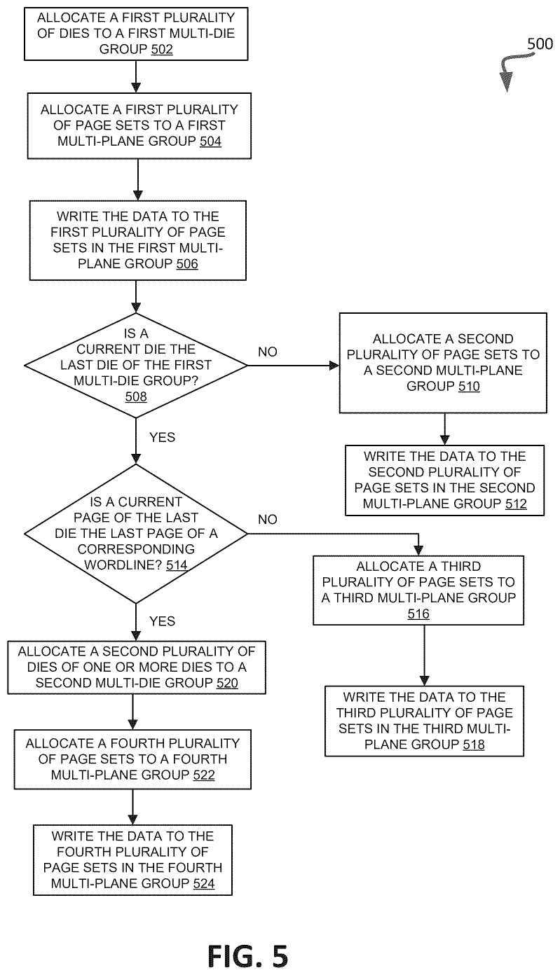

For example, parallelism in NAND flash memory write operations can be leveraged to enhance the performance and efficiency of a memory device. The structure of NAND memory allows for write operations to be dispersed across multiple parallel dies. Dispersing sequential write data across multiple dies in NAND flash memory enhances performance, increasing bandwidth for sequential write operations and reducing latency for sequential read operations. Performance is placed in priority as dispersing the write operations across multiple dies can require greater buffer capacity. This approach accelerates the data writing process, leading to increased throughput and reduced write times, and also distributes wear evenly across the dies. FIG. 5 is a flow diagram illustrating an example method of writing the data to the page set such that performance is prioritized by dispersing sequential write operations across multiple parallel dies, in accordance with some embodiments of the present disclosure.

At operation 502, the processing logic allocates a first plurality of dies of the memory device to a first multi-die group. A multi-die group (hereafter referred to as an “MDG”) includes a plurality of these dies. In some embodiments, the number of dies allocated to an MDG is predetermined and fixed by the processing logic.

At operation 504, the processing logic allocates a first plurality of page sets to a first multi-plane group, wherein the first plurality of page sets is associated with a first die of the first MDG. The first number of page sets in the first multi-plane group includes a page set from each plane in the first die. The number of page sets in a multi-plane group can vary depending on the embodiment. In some embodiments, the number of allocated page sets in a multi-plane group is fixed and predetermined by the processing logic.

At operation 506, the processing logic writes the data to the first plurality of page sets in the first multi-plane group.

At operation 508, the processing logic determines whether a current die of the first MDG is the last die of the first MDG. The current die is the die with which the multi-plane group currently being written to is associated. For example, in an MDG with five dies, when writing data to a multi-plane group associated with the fifth die, the processing logic determines that the current die is the last die.

Responsive to determining that the current die is not the last die of the first MDG, at operation 510, the processing logic allocates a second plurality of page sets to a second multi-plane group, wherein the second plurality of page sets is associated with a second die of the first MDG. In this way, the sequential write data is dispersed evenly across the dies in the MDG.

At operation 512, the processing logic writes the data to the second plurality of page sets in the second multi-plane group.

At operation 514, responsive to determining that the current die is the last die of the first MDG, the processing logic determines whether a current page of the last die is the last page of the corresponding wordline. Just as at operation 408, a current page is a page that is currently being written to. In some embodiments, the last page of a corresponding wordline is identified by its page type. For example, in a NAND memory device using a Triple-level cell (TLC) storage implementation, pages are categorized into three types: Lower Page (LP), Upper Page (UP), and Extra Page (XP). In an example wordline, the last page in a may be predetermined to be of the type XP.

Responsive to determining that the current die of the first MDG is the last die of the first MDG and that a current page of the last die is not a last page of a corresponding wordline, at operation 516, the processing logic allocates a third plurality of page sets of the one or more page sets to a third multi-plane group, wherein the third plurality of page sets is associated with a first die of the second MDG. The third plurality of page sets is associated with the first die of the first MDG. Since the last page of the corresponding wordline has not been written to and there is not a next die in the MDG from which the processing logic can allocate a plurality of page sets to a multi-plane group, the processing logic returns to the first die of the current MDG. The processing logic continues the dispersal of the sequential write operations by allocating a next plurality of page sets from the first die of the current MDG to a next multi-plane group.

At operation 518, the processing logic writes the data to the third plurality of page sets in the third multi-plane group.

Responsive to determining that the current die of the first MDG is the last die of the first MDG and that a current page of the last die is a last page of a corresponding wordline, at operation 520, the processing logic allocates a second plurality of dies of the memory device to a second MDG.

At operation 522, the processing logic allocates a fourth plurality of page sets of the one or more page sets to a fourth multi-plane group, wherein the fourth plurality of page sets is associated with a first die of the second MDG.

At operation 524, the processing logic writes the data to the fourth plurality of page sets in the fourth multi-plane group.

In some embodiments, the write operation can be performed to prioritize parity. FIG. 6 is a flow diagram of an example method of writing the data to the page set that prioritizes parity, in accordance with the present disclosure.

Parity is a method employed for error detection; it involves adding an additional bit, known as the parity bit, to a data set. This bit is calculated to make the total number of ‘l’ bits in the set either odd or even, depending on whether odd or even parity schema is being used. This allows for the detection of errors that occur when an odd number of bits have been inadvertently flipped during data storage or transmission. When data is read back, checking the parity can reveal whether an error has occurred.

A parity buffer is a dedicated area within the memory device that can store parity bits or other error-correcting code (ECC) information.

In certain configurations, such as those involving NAND technology, data is written to pages in a sequential manner. In some embodiments, a parity buffer is utilized to hold the parity bits of data that has not yet been written, retaining these bits until the data is successfully recorded on the page sets. When the data is read back, these parity bits can be used to check and ensure that the data retrieved matches what was originally written. If discrepancies are detected, indicating potential corruption, the system can use this additional information to attempt to locate and correct the errors.

RAID (Redundant Array of Independent Disks) is a technology that combines multiple disk drives into a single unit to enhance data reliability or performance. By employing various RAID levels, such as RAID 5 or RAID 6, it introduces redundancy through the use of parity data calculated and stored in one or more parity buffers. This approach allows systems to recover lost data in the event of a disk failure, making RAID with parity an effective strategy for protecting against data loss. In RAID 5, parity information can be distributed across all drives, allowing the processing logic to reconstruct data from any single drive failure (e.g., such as that caused by Asynchronous Power Loss (APL) during a write operation). RAID 6 extends this concept by storing double parity, providing the capability to recover from two simultaneous drive failures. As such, these RAID levels necessitate additional buffer space to hold the parity data before it is written to the disk, impacting the overall capacity requirements for the parity buffer.

Parity buffers are a limited resource for a memory device. In some embodiments, the processing logic halts write operations until there is adequate capacity in the memory device's parity buffer. By prioritizing closing a wordline (e.g., completing the write operations to a wordline) when writing the data to the page sets, the processing logic can sooner release the parity buffer to ensure there is enough capacity for subsequent write operations. This is because, after a wordline is complete, there is no longer data in the parity buffer that has not been written to the physical pages of the memory device (e.g., written to the page sets) and no longer needs to be stored for the purpose of write operations.

At operation 602, the processing logic allocates a first plurality of page sets of one or more page sets associated with a first die to a first multi-plane group. The first plurality of page sets in the first multi-plane group includes a page set from each plane in the first die. The number of page sets in a multi-plane group can vary depending on the embodiment. In some embodiments, the number of allocated page sets in a multi-plane group is fixed and predetermined by the processing logic.

At operation 604, the processing logic writes the data to the first plurality of page sets in the first multi-plane group.

At operation 606, the processing logic determines whether a current wordline is closed. A current wordline is closed upon the processing logic completing writing the data to the physical pages associated with that wordline.

Responsive to determining that a current wordline is closed, at operation 608, the processing logic allocates a second plurality of page sets of the one or more page sets associated with a second die to a second multi-plane group.

At operation 610, the processing logic writes the data to the second plurality of page sets in the second multi-plane group.

Responsive to determining that a current wordline is not closed, at operation 612, the processing logic allocates a third plurality of page sets of the one or more page sets of the first die to a third multi-plane group.

At operation 614, the processing logic writes the data to the third plurality of page sets in the third multi-plane group.

Returning to FIG. 2, at operation 208, the processing logic modifies, in an address translation data structure (ATDS), a logical address mapping of a TU associated with the page set. In some embodiments, the ATDS can be a logical-to-physical (L2P) mapping table storing L2P mapping information, at least a portion of which may be stored in volatile memory (e.g., Dynamic Random Access Memory (DRAM)) in the memory sub-system so that it can be accessed with minimal latency. In some embodiments, responsive to modifying, in the ATDS, the logical address mapping of the TU associated with the page set, the processing logic modifies a valid translation unit count (VTC). For example, this VTC can increase when the processing logic writes the data to allocated page sets.

In some embodiments, the processing logic performs a coherence check on the memory device. This is a process to ensure that read operations on the memory device retrieve current data reflecting the latest write operations, especially when dealing with NAND flash memory where data may be temporarily held in a buffer of the memory device for data to be written (a “write data buffer”) before being written to the page sets of the memory device.

In some embodiments, the processing logic implements a “write-back” method of writing the data to the page set. In a write-back method, a write completion response is sent once the data is transferred to a write data buffer of a memory device but before it is written to the page set, potentially leading to outdated data being read. This risk can present itself in embodiments where the processing logic modifies, in an address translation data structure (ATDS), the logical address mapping of a TU associated with the page set prior to writing the data to the page set (e.g., to the physical address); this is exemplified in an embodiment of FIG. 2 where operation 208 occurs prior to operation 206. For example, consider a situation where there is a pending write request that has not yet updated the logical-to-physical address mapping in the ATDS. If a read request is issued during this period, the system might access an outdated physical address, because the mapping for the TU associated with the page being read has not been refreshed. This would lead to retrieving incorrect or stale data from the memory device.

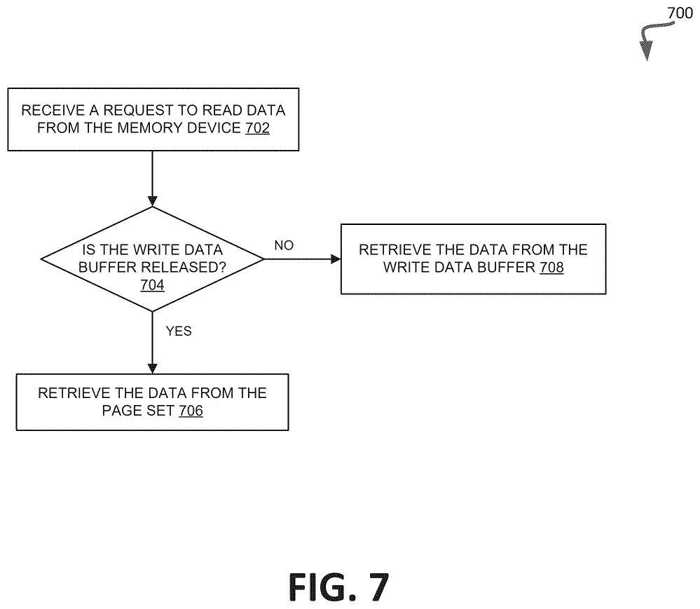

To prevent a read operation retrieving outdated data (e.g., accessing the incorrect physical address from the ATDS because the write operation has not completed the translation), a coherence check performed by the processing logic can identify the status of the memory and retrieve the data from the appropriate location in the memory device (e.g., the page set, the write data buffer, etc.). FIG. 7 illustrates an example embodiment of a coherence check, performed in accordance with some embodiments of the present disclosure. In some embodiments, the steps of FIG. 7 are repeated for each page of a page set.

At operation 702, the processing logic receives a request to read data (e.g., a read command) from the memory device. In some embodiments, this read command comes from the host. In some embodiments, this read command comes from the system. The system can request this read operation during a garbage collection operation, for example.

At operation 704, the processing logic determines whether the write data buffer is released, wherein an erase operation is performed on the write data buffer. In some embodiments, the write data buffer is released once the processing logic completes writing the data to the corresponding page sets of a wordline. Releasing the write data buffer can be performed to free space for subsequent write operations on the memory device. As such, a released write data buffer can indicate the processing logic completed writing the data to the corresponding page sets of the memory device and the ATDS is accurate.

In some embodiments, the write data buffer is determined to be released by comparing the requested logical block address from the read request with outstanding write data buffers. If the requested logical block address corresponds to an outstanding write data buffer, the system determines that the write data buffer has not been released. If the requested logical block address does not correspond to an outstanding write data buffer, the system determines that the write data buffer has been released.

Responsive to determining that the write data buffer is released, at operation 706, the processing logic retrieves the requested data from the page set using the ATDS. In some embodiments, retrieving the data from the page set involves the processing logic fetching a physical address corresponding to the page set from the ATDS and using the fetched physical address to locate and retrieve the data from the page set.

Responsive to determining that the write data buffer is not released, at operation 708, the processing logic retrieves the requested data from the write data buffer.

In some cases, the pages allocated to a page set are associated with different wordlines. Unlike when pages allocated to the page set are associated with the same wordline, because the pages are associated with different wordlines, the pages of the page set can be written to at different times. For example, consider a scenario where a page set has two pages. If these pages are associated with the same wordline, the release of the write data buffer for that wordline means the completion of the write operations to the associated page sets. A coherence check on each page yields the same result.

However, if the pages of a page set are on different wordlines, the first page can be fully written to and accessed, allowing the write data buffer holding its associated data to be released. Meanwhile, the data intended for the second page remains in the write data buffer, awaiting its turn to be written to the page set. A coherence check on each of these pages to be read returns different results (e.g., the first page has the associated write data buffer for that wordline released while the second page does not). In this scenario, the host read for a page set is divided into two parts. For the first page for which the processing logic determines that the associated write data buffer is released, as in operation 706, the processing logic retrieves the requested data from the page set using the ATDS. For the second page for which the processing logic determines that the associated write data buffer is not released, at operation 708, the processing logic retrieves the requested data from the write data buffer.

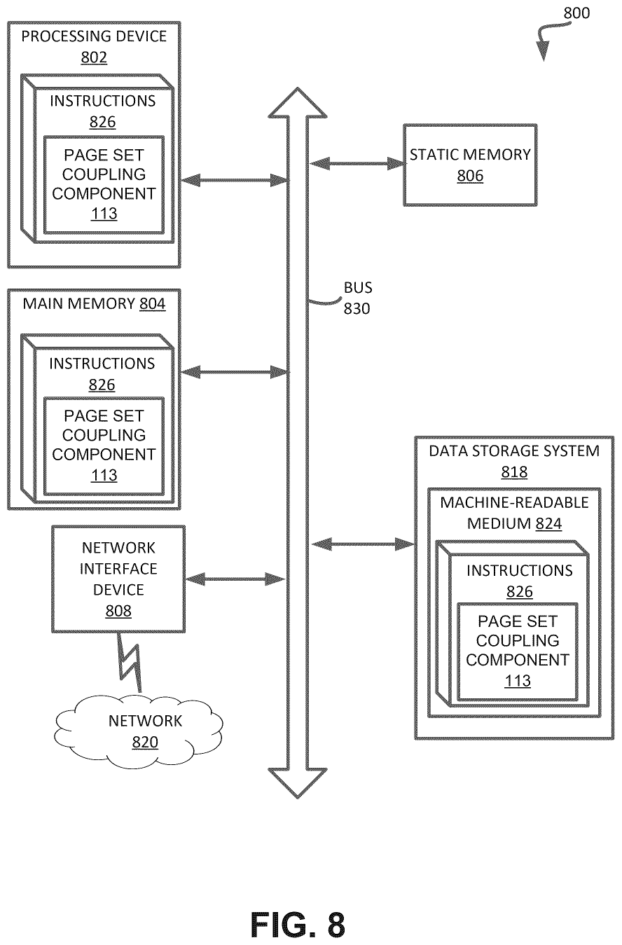

FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the Page Set Coupling component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or RDRAM, etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In one embodiment, the instructions 826 include instructions to implement functionality corresponding to a Page Set Coupling component (e.g., the Page Set Coupling component 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a request to write data to the memory device, the request comprising a data item and a logical address;
allocating a plurality of pages of the memory device to a page set, wherein the plurality of pages are associated with a same block of the memory device and sequentially numbered within the same block;
writing the data to the page set; and
modifying, in an address translation data structure (ATDS), a logical address mapping of a translation unit (TU) associated with the page set.

2. The system of claim 1, wherein writing the data to the page set comprises:
allocating, to a first multi-plane group, a first plurality of page sets of one or more page sets associated with a first die;
writing the data to the first plurality of page sets in the first multi-plane group;
responsive to determining that a current page of the first multi-plane group is a last page of a corresponding wordline, allocating, to a second multi-plane group, a second plurality of page sets of one or more page sets associated with a second die; and
writing the data to the second plurality of page sets in the second multi-plane group.

3. The system of claim 1, wherein writing the data to the page set comprises:
allocating a first plurality of dies of the memory device to a first multi-die group (MDG);
allocating, to a first multi-plane group, a first plurality of page sets, wherein the first plurality of page sets is associated with a first die of the first MDG;
writing the data to the first plurality of page sets in the first multi-plane group;
responsive to determining that a current die of the first MDG is not a last die of the first MDG, allocating, to a second multi-plane group, a second plurality of page sets, wherein the second plurality of page sets is associated with a second die of the first MDG; and
writing the data to the second plurality of page sets in the second multi-plane group.

4. The system of claim 3, further comprising:
responsive to determining that the current die of the first MDG is the last die of the first MDG and that a current page of the last die is not a last page of a corresponding wordline, allocating, to a third multi-plane group, a third plurality of page sets of the one or more page sets, wherein the third plurality of page sets is associated with a first die of the first MDG; and
writing the data to the third plurality of page sets in the third multi-plane group.

5. The system of claim 4, further comprising:
responsive to determining that the current die of the first MDG is the last die of the first MDG and that a current page of the last die is a last page of a corresponding wordline, allocating a second plurality of dies of the memory device to a second MDG; and
allocating, to a fourth multi-plane group, a fourth plurality of page sets of the one or more page sets, wherein the fourth plurality of page sets is associated with a first die of the second MDG; and
writing the data to the fourth plurality of page sets in the fourth multi-plane group.

6. The system of claim 1, wherein writing the data to the page set comprises:
allocating, to a first multi-plane group, a first plurality of page sets of page sets associated with a first die;
writing the data to the first plurality of page sets in the first multi-plane group;
responsive to determining that a current wordline is closed, allocating, to a second multi-plane group, a second plurality of page sets of the one or more page sets associated with a second die; and
writing the data to the second plurality of page sets in the second multi-plane group.

7. The system of claim 1, further comprising:
responsive to modifying, in the ATDS, the logical address mapping of the TU associated with the page set, modifying a valid translation unit count (VTC) associated with the memory device.

8. The system of claim 1, further comprising:
writing the data to a write data buffer of the memory device; and
releasing the write data buffer.

9. The system of claim 8, further comprising:
receiving a request to read data from the memory device; and
responsive to determining that the write data buffer is released, retrieving the data from the page set, wherein a physical address corresponding to the page set is fetched from the ATDS.

10. A method comprising:
receiving a request to write data to a memory device, the request comprising a data item and a logical address;
allocating a plurality of pages of the memory device to a page set, wherein the plurality of pages are associated with a same block of the memory device and sequentially numbered within the same block;
writing the data to the page set; and
modifying, in an address translation data structure (ATDS), a logical address mapping of a translation unit (TU) associated with the page set.

11. The method of claim 10, wherein writing the data to the page set further comprises:
allocating, to a first multi-plane group, a first plurality of page sets of one or more page sets associated with a first die;
writing the data to the first plurality of page sets in the first multi-plane group;
responsive to determining that a current page of the first multi-plane group is a last page of a corresponding wordline, allocating, to a second multi-plane group, a second plurality of page sets of one or more page sets associated with a second die; and
writing the data to the second plurality of page sets in the second multi-plane group.

12. The method of claim 10, wherein writing the data to the page set further comprises:
allocating a first plurality of dies of the memory device to a first multi-die group (MDG);
allocating, to a first multi-plane group, a first plurality of page sets, wherein the first plurality of page sets is associated with a first die of the first MDG;
writing the data to the first plurality of page sets in the first multi-plane group;
responsive to determining that a current die of the first MDG is not a last die of the first MDG, allocating, to a second multi-plane group, a second plurality of page sets, wherein the second plurality of page sets is associated with a second die of the first MDG; and
writing the data to the second plurality of page sets in the second multi-plane group.

13. The method of claim 10, wherein writing the data to the page set further comprises:
allocating, to a first multi-plane group, a first plurality of page sets of page sets associated with a first die;
writing the data to the first plurality of page sets in the first multi-plane group;
responsive to determining that a current wordline is closed, allocating, to a second multi-plane group, a second plurality of page sets of the one or more page sets associated with a second die; and
writing the data to the second plurality of page sets in the second multi-plane group.

14. The method of claim 10, further comprising:
writing the data to a write data buffer of the memory device; and
releasing the write data buffer.

15. The method of claim 14, further comprising:
receiving a request to read data from the memory device; and
responsive to determining that the write data buffer is released, retrieving the data from the page set, wherein a physical address corresponding to the page set is fetched from the ATDS.

16. A non-transitory computer-readable storage medium comprising instructions that, when executed by a processing device, cause the processing device to perform operations comprising:
receiving a request to write data to a memory device, the request comprising a data item and a logical address;
allocating a plurality of pages of the memory device to a page set, wherein the plurality of pages are associated with a same block of the memory device and sequentially numbered within the same block;
writing the data to the page set; and
modifying, in an address translation data structure (ATDS), a logical address mapping of a translation unit (TU) associated with the page set.

17. The non-transitory computer-readable storage medium of claim 16, wherein writing the data to the page set further comprises:
allocating, to a first multi-plane group, a first plurality of page sets of one or more page sets associated with a first die;
writing the data to the first plurality of page sets in the first multi-plane group;
responsive to determining that a current page of the first multi-plane group is a last page of a corresponding wordline, allocating, to a second multi-plane group, a second plurality of page sets of one or more page sets associated with a second die; and
writing the data to the second plurality of page sets in the second multi-plane group.

18. The non-transitory computer-readable storage medium of claim 16, wherein writing the data to the page set further comprises:
allocating a first plurality of dies of the memory device to a first multi-die group (MDG);
allocating, to a first multi-plane group, a first plurality of page sets, wherein the first plurality of page sets is associated with a first die of the first MDG;
writing the data to the first plurality of page sets in the first multi-plane group;
responsive to determining that a current die of the first MDG is not a last die of the first MDG, allocating, to a second multi-plane group, a second plurality of page sets, wherein the second plurality of page sets is associated with a second die of the first MDG; and
writing the data to the second plurality of page sets in the second multi-plane group.

19. The non-transitory computer-readable storage medium of claim 16, wherein writing the data to the page set further comprises:
allocating, to a first multi-plane group, a first plurality of page sets of page sets associated with a first die;
writing the data to the first plurality of page sets in the first multi-plane group;
responsive to determining that a current wordline is closed, allocating, to a second multi-plane group, a second plurality of page sets of the one or more page sets associated with a second die; and
writing the data to the second plurality of page sets in the second multi-plane group.

20. The non-transitory computer-readable storage medium of claim 16, further comprising:
writing the data to a write data buffer of the memory device; and
releasing the write data buffer.
